(19) United States
(12) Patent Application Publication
(10) Pub. No.: US 2004/0109401 A1
(43) Pub. Date: Jun. 10, 2004

(54) Optical apparatus and optical pickup

(75) Inventor: Masakazu Ogasawara, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/724,626

(22) Filed: Dec. 2, 2003

(30) Foreign Application Priority Data
Dec. 6, 2002 (JP) P2002-355101

(51) Int. Cl. G11B 7/135

(52) U.S. Cl. 369/112.19; 369/112.2; 369/112.24

(57) ABSTRACT

The invention provides an optical apparatus. and the optical pickup of that optical apparatus, for which the number of parts of the optical pickup can be reduced and thus a data-recording apparatus that contains this optical pickup can be made more compact. An optical pickup P1 that projects a red-LASER beam RL for a DVD and a blue-LASER beam for a high-recording-density optical disc, whose optical axes coincide with each other, onto the respective optical discs, and comprising: a first expander lens 4 and second expander lens 6 that correct distortion that occurs in the blue-LASER beam BL and red-LASER beam RL; and a dichroic prism 5 that is located between the first expander lens 4 and second expander lens 6 in the optical path of the blue-LASER beam BL and its reflected beam; and where the second expander lens 6, working together with the first expander lens 4, corrects spherical distortion that occurs in the blue-LASER beam BL, as well as converts the red-LASER beam RL to a parallel beam.

### BACKGROUND OF THE INVENTION

1. Field of the Invention

This invention relates to an optical apparatus and optical pickup, and more particularly to an optical apparatus and the optical pickup in that optical apparatus which are used for recording or reproducing data on an optical recording medium.

2. Description of the Related Art

In recent years, in the field of using optical discs as optical recording media, the amount of data that can be recorded on one optical disc has drastically increased.

Also, in recent years, the use of DVDs (Digital Versatile Disc), on which several times more data can be recorded than on a conventional CD (Compact Disc), has become common, however, in addition to this, standardization of optical discs, for which recording and reproduction are performed using a blue LASER beam (having an oscillation wavelength of approximately 400 nm) as the light beam, is advancing. In the case of optical discs for which this kind of blue LASER beam is used as the light beam, the amount of data that can be recorded is expected to reach 20 GBytes or more.

Recently, CDs and DVDs mentioned above are both widely used, however, in addition to these, it is expected that in the near future optical discs corresponding to a blue LASER beam will also become widely used.

Taking into considering this situation, research and development of a data-recording apparatus or data-reproduction apparatus that is capable of recording or reproducing data on these kinds of optical discs is being carried out such that there will be compatibility and data will be able to be recorded or reproduced on different kinds of optical discs (for example, on both a CD or DVD) by one apparatus.

In a conventional data-recording apparatus, using a separate optical pickup for each kind of optical disc was not performed due to cost or difficulty of construction, and generally an optical pickup was constructed such that it was possible to record and reproduce data on different kinds of optical discs using one optical pickup.

More specifically, in the case of mounting and using both an optical disc that corresponds to a blue LASER beam and a DVD in the same data-reproduction apparatus, conventionally, the optical path of the blue LASER beam and the optical path of the red LASER beam for the DVD were located independently, and just before these LASER beams entered the object lens, each LASER beam was guided such that both of the optic axes were aligned. In this case, the object lens performed the function of condensing the light from the blue LASER beam and the red LASER beam and projecting the beam on the optical disc that was mounted at the time.

Also, in that case, a collimating lens that converts each of the output beams into parallel beams and a expander lens used for correcting spherical distortion were separately and independently located for the blue LASER beam and red LASER beam.

However, with the construction of the conventional optical pickup that was developed for a data-recording apparatus having the compatibility mentioned above, lenses, such as the aforementioned collimating lens, were separate for each light beam, so as a result, there were problems in that the optical pickup itself became large and complicated, and thus it was difficult to make the data-recording apparatus itself more compact, and the manufacturing cost increased.

### SUMMARY OF THE INVENTION

Thereupon, the present invention has been made in view of the above-described points in problem and has an object of this invention is to provide an optical apparatus and the optical pickup of that optical apparatus for which the number of parts of the optical pickup can be reduced, and thus a data-recording apparatus that contains this optical pickup can be made more compact, for example.

The above object of the present invention can be achieved by an optical apparatus that projects a first light beam having a first wavelength and a second light beam having a second wavelength that is different than the first wavelength onto an optical recording medium, and that guides a first reflected beam, which is the reflected beam of the first light beam that is reflected from the optical recording medium, and a second reflected beam, which is the reflected beam of the second light beam that is reflected from the optical recording medium. The optical apparatus is provided with: a distortion-correction device for correcting the distortion that occurs in the first light beam and first reflected beam, and comprises a stationary optical device and a movable optical. device; and a light-guiding device that is located between the stationary optical device and movable optical device in the optical path of the first light beam and the first reflected beam, and guides the first light beam and the second light beam, whose optic axes coincide with each other, to the optical recording device; and wherein the movable optical device works together with the stationary optical device to correct the distortion, and converts the second light beam to a parallel beam.

According to the optical apparatus, the light-guiding device is located between the stationary optical device and movable optical device in the optical path of the first light beam and the first reflected beam, and guides the first light beam and the second light beam, whose optic axes coincide with each other, to the optical recording device, and the movable optical device works together with the stationary optical device to correct the distortion, and converts the second light beam to a parallel beam. Therefore, it is not necessary to have a special collimating lens for the second light beam, and thus it is possible to reduce the number of parts of the optical apparatus and make the optical apparatus more compact.

In one aspect of the optical apparatus, the distortion-correction device corrects the distortion and converts the first light beam to a parallel beam.

According to this aspect, the distortion-correction device corrects the distortion and converts the first light beam to a parallel beam. Therefore, it is not necessary to have a special collimating lens for the second light beam and a special collimating lens for the first light beam. Thus it is possible to further reduce the number of parts of the optical apparatus and make the optical apparatus more compact.

In another aspect of the optical apparatus, the stationary optical device converts the first reflected light to the light-flux form necessary for receiving the first reflected beam.

According to this aspect, since the stationary optical device converts the first reflected light to the light-flux form necessary for receiving the first reflected beam, it is possible to omit the detection lens for the first reflected light, and thus it is possible to further reduce the number of parts of the optical apparatus and make the optical apparatus more compact.

In further aspect of the optical apparatus, the stationary optical device is a polarization hologram that is formed on the incident surface where the first light beam enters the light-guiding device.

According to this aspect, since the stationary optical device is a polarization hologram that is formed on the incident surface where the first light beam enters the light-guiding device, it is possible to omit the detection lens for the first reflected light, and thus it is possible to further reduce the number of parts of the optical apparatus and make the optical apparatus more compact.

The above object of the present invention can be achieved by an optical pickup. The optical pickup is provided with: an optical apparatus that projects a first light beam having a first wavelength and a second light beam having a second wavelength that is different than the first wavelength onto an optical recording medium, and that guides a first reflected beam, which is the reflected beam of the first light beam that is reflected from the optical recording medium, and a second reflected beam, which is the reflected beam of the second light beam that is reflected from the optical recording medium, and comprising: a distortion-correction device for correcting the distortion that occurs in the first light beam and first reflected beam, and comprises a stationary optical device and a movable optical device; and a light-guiding device that is located between the stationary optical device and movable optical device in the optical path of the first light beam and the first reflected beam, and guides the first light beam and the second light beam, whose optic axes coincide with each other, to the optical recording device; and wherein the movable optical device works together with the stationary optical device to correct the distortion, and converts the second light beam to a parallel beam; a first light-beam-emitting device for emitting the first light beam; a second light-beam-emitting device for emitting the second light beam; a first light-receiving device for receiving the first reflected beam that passes through the optical apparatus, and generating a corresponding first received-light signal; and a second light-receiving device for receiving the second reflected beam that passes through the optical apparatus, and generating a corresponding second received-light signal.

According to the optical pickup, the light-guiding device is located between the stationary optical device and movable optical device. in the optical path of the first light beam and the first reflected beam, and guides the first light beam and the second light beam, whose optic axes coincide with each other, to the optical recording device, and the movable optical device works together with the stationary optical device to correct the distortion, and converts the second light beam to a parallel beam. Therefore, it is not necessary to have a special collimating lens for the second light beam, and thus it is possible to reduce the number of parts of the optical pickup and make the optical pickup more compact.

### BRIEF DESCRIPTION OF THE DRAWINGS

FIG. 1 is a schematic diagram of the construction of the optical pickup of a first embodiment of the invention;

FIG. 2 is a schematic diagram of the construction of the optical pickup of a second embodiment of the invention;

FIG. 3 is a schematic diagram of the construction of the optical pickup of a third embodiment of the invention;

FIG. 4 is a schematic diagram of the construction of the optical pickup of a fourth embodiment of the invention;

### DESCRIPTION OF THE PREFERRED EMBODIMENTS

Next, the preferred embodiments of the invention will be explained based on the drawings.

Each of the embodiments explained below are embodiments in which the invention is applied to an optical pickup that is used in a data-recording apparatus or data-reproduction apparatus that is capable of recording or reproducing optical data on both a DVD and an optical disc (blue-LASER disc) that uses a blue-LASER beam as the light beam (a light beam using a blue LASER beam will hereafter be called a blue-LASER beam).

(I) Embodiment 1

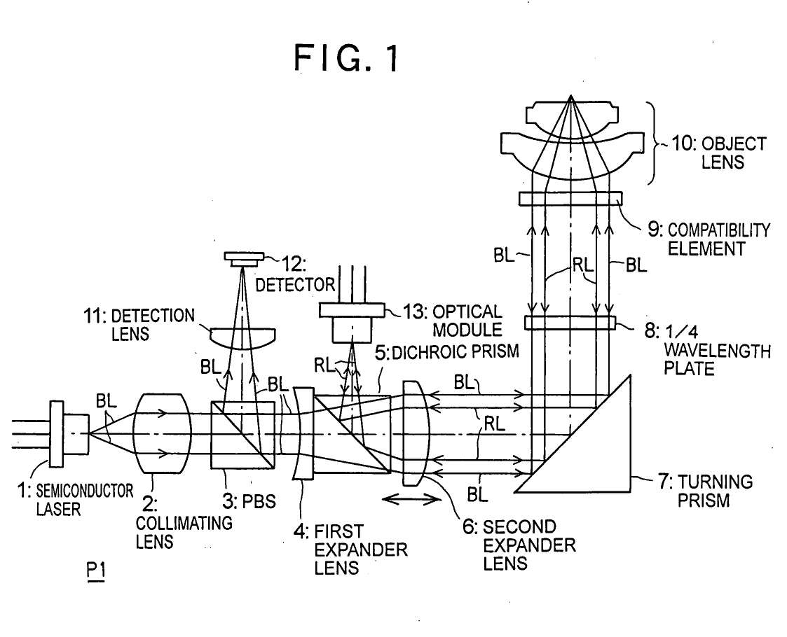

First, FIG. 1 will be used to explain a first embodiment of the invention. FIG. 1 is a schematic diagram showing the construction of the optical pickup of this first embodiment.

As shown in FIG. 1, the optical pickup of this first embodiment comprises: a semiconductor LASER 1 as a first light-emission device; a collimating lens 2; a PBS (Polarization Beam Slitter) 3; a concave first expander lens 4 as a stationary optical device; a dichroic prism 5 as a light-guiding device; a convex second expander lens 7 as a movable optical device; a turning prism 7; a ¼ wavelength plate 8; a compatibility element 9; an object lens 10; a detection lens 11, a detector 12 as a first light-receiving device, and an optical module 13 as a second light-emitting device and second light-receiving device.

Next, the operation will be explained.

First, the operation of all of the components with respect to the blue-LASER beam will be explained.

The semiconductor LASER 1 generates a blue-LASER beam BL as a first light beam having linear polarization in just one direction, and emits that beam toward the collimating lens 2.

The collimating lens 2 converts the emitted blue-LASER beam BL to a parallel beam and emits it toward the PBS 3.

Then, the PBS 3 lets the emitted blue-LASER beam BL pass through and emits it toward the first expander lens 4 that is attached to arranged and located on the incident surface for the blue-LASER beam BL on the dichroic prism 5.

The first expander lens 4 expands the cross-sectional area of the light flux of the emitted blue-LASER beam BL, and emits it toward the dichroic prism 5.

Next, the dichroic prism 5 lets the emitted blue-LASER beam BL pass through and emits it toward the second expander lens 6.

The second expander lens 6 returns the emitted blue-LASER beam BL to a parallel beam again, and emits it toward the turning prism 7.

The turning prism 7 changes the direction of the optic axis of the emitted blue-LASER beam BL to an upward vertical direction, and emits the beam toward the ¼ wavelength plate 8.

Next, the ¼ wavelength plate 8 converts the polarization of the emitted blue-LASER beam BL from linear polarization to circular polarization, and emits the beam toward the compatibility element 9.

Here, the compatibility element 9 is an optical-path-conversion element for allowing the blue-LASER beam BL and the red-light LASER beam for the DVD (hereafter called the red-LASER beam) share the object lens 10, and more specifically, as shown in FIG. 1, it has the function of letting the blue-LASER beam BL pass through, and condensing the red-LASER beam RL.

The blue-LASER beam BL that passes through the compatibility element 9 is condensed to the focus point of the object lens 10, and projected onto the optical disc (not shown in the figure).

Next, the direction of the circular polarization of the blue-LASER beam BL that is reflected by the optical disc is changed due to the reflection and it enters as is again into the object lens 10.

The object lens 10 returns the incident blue-LASER beam BL to a parallel beam and emits it toward the compatibility element 9.

By doing this, the compatibility element 9 lets the emitted blue-LASER beam BL pass through as is and emits it toward the ¼ wavelength plate 8.

Next, the ¼ wavelength plate 8 converts the circular polarization of the emitted blue-LASER beam BL to linear polarization, and emits it toward the turning prism 7. At that time, the direction of polarization of the blue-LASER beam BL that is emitted from the ¼ wavelength plate 8 is 90-degrees different than the direction of polarization of the blue-LASER beam BL that enters the ¼ wavelength plate 8 from the second expander lens 6 by way of the turning prism 7.

Next, the turning prism 7 changes the direction of the optic axis of the emitted blue-LASER beam BL to a beam in the horizontal direction, and emits it toward the second expander lens 6.

By doing this, the second expander lens 6 narrows the cross-sectional area of the light flux of the emitted blue-LASER beam BL, and emits it toward the dichroic prism 5.

The dichroic prism 5 lets the emitted blue-LASER beam BL pass through and emits it toward the first expander lens 4.

Then the first expander lens 4 returns the emitted blue-LASER beam BL to a parallel beam again, and emits it toward the PBS 3.

Next, the PBS 3 reflects the blue-LASER beam BL from the first expander lens 4, whose direction of polarization has been changed 90-degrees when compared with the beam that enters from the collimating lens 2, and changes the direction of the optic axis such that it faces upward in a vertical direction, and emits the beam toward the detection lens 11.

The detection lens 11 converts the form of the light flux of the emitted blue-LASER beam BL to the form of a light flux to be received by the detector 12, and emits it toward the detector 12.

To explain the form of the light flux in more detail, when the light receiving method used by the detector 12 (in other words, the tracking-servo method or focus-servo method of the data-recording apparatus that contains the optical pickup P1) is the astigmatic method, a circular lens is used as the detection lens 11, and it gives an astigmatism to the blue-LASER beam BL before emitting it toward the detector 12.

On the other hand, when the light-receiving method of the detector is the spot-size method, the detection lens 12 divides the blue-LASER beam in two and then emits it toward the detector 12.

The detector 12 then receives the emitted blue-LASER beam BL and generates a corresponding received-light signal and outputs it to a demodulation-detection unit or the like (not shown in the figure).

Here, in the series of operations performed on the blue-LASER beam described above, the second expander lens 6 is moved in two directions as indicated by both arrows in FIG. 1 by an actuator (not shown in the figure). Also, by using the change of the distance of this movement together with the function of changing the cross-sectional area of the light flux of the blue-LASER beam B by the first expander lens 4 and second expander lens 6, the spherical distortion of the light path is corrected as the blue-LASER beam BL advances.

Next, the operation of all of the parts with respect to the red-LASER beam RL, or second light beam, that is used when recording or reproducing data on a DVD and that has a longer wavelength (approximately 650 nm) than the blue-LASER beam BL described above, will be explained.

First, the light-emitting unit (not shown in the figure) inside the optical module 13 generates a red-LASER beam RL having linear polarization in only one direction, and emits that beam to the dichroic prism 5.

Next, the dichroic prism 5 reflects the emitted red-LASER beam RL and emits it toward the second expander lens 6. At this time, in the forward and return optical path between the second expander lens 6 and the object lens 10, the optic axis of the red-LASER beam RL coincides with the optic axis of the blue-LASER beam described above.

By doing this, the second expander lens 6 converts the emitted red-LASER beam RL to a parallel beam, and emits it toward the turning prism 7.

The turning prism 7 changes the direction of the optic axis of the emitted red-LASER beam RL to an upward vertical direction, and emits it toward the ¼ wavelength plate 8.

Next, the ¼ wavelength plate 8 converts the linear polarization of the emitted red-LASER beam RL to circular polarization, and emits it toward the compatibility element 9.

Also, the compatibility element 9 condenses the red-LASER beam RL, and emits it toward the object lens 10.

By doing this, the object lens 10 condenses the emitted red-LASER beam RL to the location of the focal point, and projects the beam onto the optical disc (not shown in the figure).

Next, the direction of polarization of the circular polarized red-LASER beam RL that is reflected by the optical disc is changed by the reflection and enters the object lens 10 again.

The object lens 10 returns the entering red-LASER beam RL to a parallel beam, and emits it toward the compatibility element 9.

Then, the compatibility element 9 converts the emitted red-LASER beam RL to a parallel beam, and emits it to the ¼ wavelength plate 8.

Next, the ¼ wavelength plate 8 converts the circular polarization of the emitted red-LASER beam RL to linear polarization, and emits it toward the turning prism 7. At this time, as in the case of the blue-LASER beam BL, the direction of polarization of the red-LASER beam RL that is emitted from the ¼ wavelength plate 8 is 90-degrees different than the direction of polarization of the red-LASER beam RL that is emitted from the second expander lens 6 and enters the ¼ wavelength plate 8 by way of the turning prism 7.

Also, the turning prism 7 changes the direction of the optic axis of the emitted red-LASER beam RL to the horizontal direction, and emits it toward the second expander lens 2.

Then, the second expander lens 6 narrows the cross-sectional area of the light flux of the emitted red-LASER beam RL, and emits it toward the dichroic prism 5.

The dichroic prism 5 changes the direction of the optic axis of the emitted red-LASER beam RL, and emits it toward the optical module 13.

The light-receiving unit (not shown in the figure) inside the optical module 13 (normally this is the same part as the light-receiving unit (not shown in the figure) described above) receives the emitted red-LASER beam RL and generates a corresponding received-light signal and outputs it to a demodulation-detection unit or the like (not shown in the figure).

Here, in the series of operations performed on the red-LASER beam RL described above, the second expander lens 2 acts on the red-LASER beam RL as a collimating lens that converts the red-LASER beam RL to a parallel beam.

In other words, in the pickup P1 of this first embodiment described above, the second expander lens 6, together with the first expander lens 4, functions as a spherical-distortion correction element for the blue-LASER beam BL and its reflected beam, and functions as a collimating lens for the red-LASER beam RL.

Therefore, when designing the second expander lens 6 of this first embodiment, it is necessary to perform design with this point in mind such that the expander lens sufficiently reduces the color distortion in the red-LASER beam RL, and such that together with the first expander lens 4, it performs proper magnification of the blue-LASER beam BL.

As explained above, with the construction of the pickup of this first embodiment, the optic axis of the blue-LASER beam BL coincides with the optic axis of the red-LASER beam RL, and a dichroic prism 5 that guides the blue-LASER beam BL and red-LASER beam RL in the direction toward the optical disc is placed between the first expander 4 and second expander 6 in the optical path of the blue-LASER beam BL and its reflected beam; and the second expander lens 6, working together with the first expander lens 4, corrects spherical distortion in the blue-LASER beam BL and its reflected beam, as well as functions to convert the red-LASER beam RL in the forward path to the optical disk to a parallel beam, so it is not necessary to have a special collimating lens for the red-LASER beam RL, and thus it is possible to reduce the number of parts of the optical pickup P1 and make the optical pickup P1 more compact.

(II) Embodiment 2

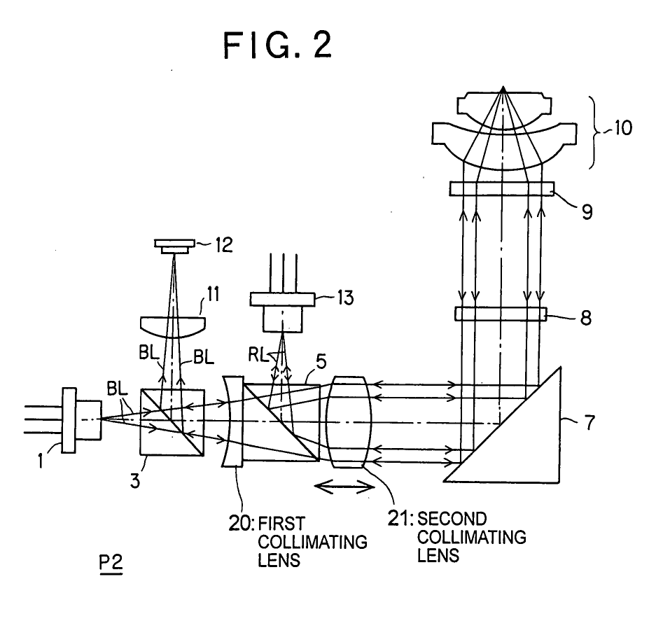

Next, FIG. 2 will be used to explain a second embodiment of the invention. FIG. 2 is a schematic diagram showing the construction of the optical pickup of this second embodiment. Also, in FIG. 2, the same reference numbers will be used for parts that are identical with parts of the optical pickup P1 of the first embodiment shown in FIG. 1, and a detailed explanation of those parts will be partially omitted.

In the first embodiment described above, the case of reducing the number of parts of the optical pickup P1 by omitting a special collimating lens for the red-LASER beam was explained, however, in the second embodiment described below, the construction of the optical pickup is simplified by further reducing the number of parts.

As shown in FIG. 2, the optical pickup P2 of this second embodiment comprises the same semiconductor LASER 1, PBS 3, dichroic prism 5, turning prism 7, ¼ wavelength plate 8, compatibility element 9, object lens 10, detection lens 11, detector 12 and optical module 13 as in the first embodiment, as well as it comprises a concave first collimating lens 20 and convex second collimating lens 21.

Next, the operation will be explained.

First, the operation of each part will be explained for the blue-LASER beam BL.

First, the semiconductor LASER 1 generates a blue-LASER beam BL that is the same as that of the first embodiment, and emits it toward the PBS 3.

Then, the PBS 3 lets the emitted blue-LASER beam BL pass through, and emits it toward the first collimating lens 20 that is attached to and located on the surface of where the blue-LASER beam BL enters the dichroic prism 5.

The first collimating lens 20 expands the cross-sectional area of the light flux of the emitted blue-LASER beam BL, and emits it to the dichroic prism 5.

Next, the dichroic prism 5 lets the emitted blue-LASER beam pass through, and emits it toward the second collimating lens 21.

The second collimating lens 21 then converts the emitted blue-LASER beam BL to a parallel beam, and emits it toward the turning prism 7.

The turning prism 7 changes the direction of the optic axis of the emitted blue-LASER beam to an upward vertical direction, and emits it toward the ¼ wavelength plate 8.

Next, the ¼ wavelength plate 8 converts the polarization of the emitted blue-LASER beam BL from linear polarization to circular polarization, and emits it toward the compatibility element 9.

Also, the blue-LASER beam that passes through the compatibility element 9 is condensed by the object lens 10 to its focal point and projected onto the optical disc (not shown in the figure).

Next, the direction of the circular polarization of the blue-LASER beam BL that is reflected by the optical disc is changed by the reflection and then it enters the object lens 10 again.

The object lens 10 returns the entering blue-LASER beam BL to a parallel beam, and emits it toward the compatibility element 9.

From this, the compatibility element 9 lets the emitted blue-LASER beam BL pass through as is, and emits it toward the ¼ wavelength plate 8.

As in the first embodiment, the ¼ wavelength plate 8 converts the circular polarization of the emitted blue-LASER beam BL to linear polarization, and emits the beam toward the turning prism 7.

The turning prism 7 changes the direction of the optic axis of the emitted blue-LASER beam BL to a horizontal direction, and emits the beam toward the second collimating lens 21.

The second collimating lens 21 narrows the cross-sectional area of the light flux of the emitted blue-LASER beam BL, and emits it toward the dichroic prism 5.

The dichroic prism 5 lets the emitted blue-LASER beam BL pass through, and emits it toward the first collimating lens 20.

The first collimating lens 4 corrects the color distortion of the emitted blue-LASER beam BL as it lets the blue-LASER beam BL pass through, and emits it toward the PBS 3.

Next, the PBS 3 reflects the blue-LASER beam BL from the first collimating lens 20, whose direction of polarization has changed 90-degrees in comparison with the beam that was emitted from the semiconductor LASER 1, and changes the direction of its optical axis, them emits it toward the detection lens 11.

Also, the detection lens 11 converts the form of the light flux of the emitted blue-LASER beam BL in the same way as was done in the first embodiment to a light-flux form for being received by the detector 12, then emits the beam toward the detector 12.

From this, the detector 12 receives the emitted blue-LASER beam BL and generates a corresponding received-light signal, then outputs it to the demodulation-detection unit (not shown in the figure).

Here, in the series of operations performed on the blue-LASER beam BL described above, the second collimating lens 21 is moved in two directions as shown by the direction of the arrows in FIG. 2 in the same way as in the first embodiment. Also, by using the change of the distance of this movement together with the function of changing the cross-sectional area of the light flux of the blue-LASER beam B by the first collimating lens 20 and second collimating lens 21, the spherical distortion of the light path is corrected as the blue-LASER beam BL advances.

In addition, in the optical pickup P2 of this second embodiment, the second collimating lens 21 functions as the collimating lens (collimating lens 2 in the first embodiment) located in the forward path of the blue-LASER beam BL toward the optical disc.

Next, the operation of each of the parts will be explained for the red-LASER beam RL.

First, the light-receiving unit (not shown in the figure) inside the optical module 13 generates a red-LASER beam RL having linear polarization in only one direction, and emits the beam to the dichroic prism 5.

Next, the dichroic prism 5 reflects the emitted red-LASER beam RL in the same way as was done in the first embodiment, and emits it toward the second collimating lens 21.

From this, the second collimating lens 21 converts the emitted red-LASER beam RL to a parallel beam, and emits it toward the turning prism 7.

The turning prism 7 changes the direction of the optic axis of the emitted red-LASER beam RL to an upward vertical direction, and. emits the beam toward the ¼ wavelength plate 8.

Next, the ¼ wavelength plate 8 converts the polarization of the emitted red-LASER beam RL from linear polarization to circular polarization, and emits the beam toward the compatibility element 9.

The compatibility element 9 condenses the red-LASER beam RL, and emits it toward the object lens 10.

From this, the object lens condenses the emitted red-LASER beam RL to the position of its focal point, and projects it onto the optical disc (not shown in the figure).

Next, the direction of circular polarization of the red-LASER beam RL that is reflected by the optical disc changes due to the reflection, and that beam enters the object lens 10 again.

The object lens 10 returns the entering red-LASER beam RL to a parallel beam, and emits it toward the compatibility element 9.

From this, the compatibility element 9 converts the emitted red-LASER beam RL to a parallel beam, and emits it toward the ¼ wavelength plate 8.

Next, as in the first embodiment, the ¼ wavelength plate 8 converts the direction of polarization of the emitted red-LASER beam RL from circular polarization to linear polarization, and emits the beam toward the turning prism 7.

The turning prism 7 changes the direction of the optic axis of the emitted red-LASER beam RL to a horizontal direction, and emits the beam toward the second collimating lens 21.

The second collimating lens 21 narrows the cross-sectional area of the light flux of the emitted red-LASER beam RL, and emits the beam toward the dichroic prism 5.

The dichroic prism 5 changes the direction of the optic axis of the emitted red-LASER beam RL, and emits it toward the optical module 13.

From this, the light-receiving unit (not shown in the figure) inside the optical module 13 receives the emitted red-LASER beam RL and generates a corresponding received-light signal, then outputs it to a demodulation-detection unit or the like (not shown in the figure).

Here, in the series of operation performed on the red-LASER beam RL described above, the second collimating lens 21 acts on the red-LASER beam RL as a collimating lens that converts the red-LASER beam to a parallel beam.

In other words, in the pickup P2 of this second embodiment described above, the second collimating lens 21, together with the first collimating lens 20, functions as a spherical-distortion correction element and collimating lens for the blue-LASER beam BL and its reflected beam, and functions as a collimating lens for the red-LASER beam RL.

Therefore, when designing the second collimating lens 21 of this second embodiment, it is necessary to perform design with this point in mind such that the second collimating lens 21 sufficiently reduces the color distortion in the red-LASER beam RL, and such that the focal-point distance of the blue-LASER beam BL when the first collimating lens 20 is combined with the second collimating lens 21 is longer than that of just the second collimating lens 21, and such that the color distortion of the blue-LASER beam BL is absorbed by the action of the second collimating lens 21.

As explained above, with the construction of the pickup P2 of this second embodiment, the optic axis of the blue-LASER beam BL coincides with the optic axis of the red-LASER beam RL, and a dichroic prism 5 that guides the blue-LASER beam BL and red-LASER beam RL in the direction toward the optical disc is placed between the first collimating lens 20 and second collimating lens 21 in the optical path of the blue-LASER beam BL and its reflected beam; and the second collimating lens 21, working together with the first collimating lens 20, corrects spherical distortion in the blue-LASER beam BL and its reflected beam, as well as functions to convert the red-LASER beam RL in the forward path to the optical disk to a parallel beam, so it is not necessary to have a special collimating lens for the red-LASER beam RL and a special collimating lens for the blue-LASER beam BL, and thus it is possible to further reduce the number of parts of the optical pickup P2 and make the optical pickup P2 more compact.

(III) Embodiment 3

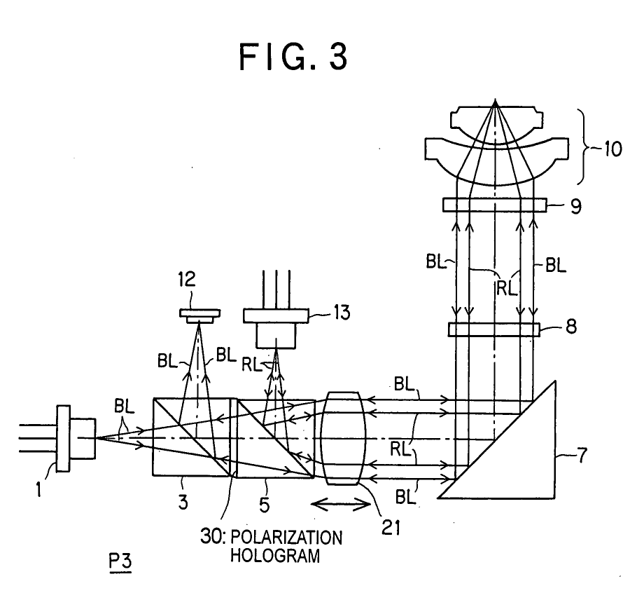

Next, FIG. 3 will be used to explain a third embodiment of the invention. FIG. 3 is a schematic diagram of the optical pickup of this third embodiment. Also, in FIG. 3, the same reference numbers will be used for parts that are identical with parts of the optical pickup P1 of the first embodiment shown in FIG. 1 and the optical pickup P2 of the second embodiment shown in FIG. 2, and a detailed explanation of those parts will be partially omitted.

In the second embodiment described above, the case of reducing the number of parts of the optical pickup P2 by omitting a special collimating lens for the red-LASER beam RL and a special collimating lens for the blue-LASER beam BL was explained, however, in the third embodiment described below, the construction of the optical pickup is simplified by further reducing the number of parts.

As shown in FIG. 3, the optical pickup P3 of this third embodiment comprises the same semiconductor LASER 1, PBS 3, dichroic prism 5, turning prism 7, ¼ wavelength plate 8, compatibility element 9, object lens 10, detector 12, optical module 13 and second collimating lens 21 as in the second embodiment, as well as it comprises a polarization hologram 30 that is located in the optical path of the blue-LASER beam BL and its reflected beam in between the PBS 3 and dichroic prism 5.

Next, the operation will be explained.

First, the operation of each of the parts will be explained for the blue-LASER beam BL.

First, as in the first and second embodiments, the semiconductor LASER 1 generates a blue-LASER beam BL, and emits it toward the PBS 3.

Then, the PBS 3 lets the emitted blue-LASER beam BL pass through, and emits it toward the polarization hologram 30 that is located between the dichroic prism 5 and PBS 3.

Also, the polarization hologram 30 expands the cross-sectional area of the light flux of the emitted blue-LASER beam BL, and emits the beam to the dichroic prism 5. When doing this, the polarization hologram 30 performs the same operation on the blue-LASER beam BL as the first collimating lens 20 in the second embodiment.

Next, the dichroic prism 5 lets the emitted blue-LASER beam BL pass through, and emits it toward the second collimating lens 21.

The second collimating lens 21 then converts the emitted blue-LASER beam BL to a parallel beam, and emits it toward the turning prism 7.

Also, the turning prism 7 changes the direction of the optic axis of the emitted blue-LASER beam BL to an upward vertical direction, and emits the beam toward the ¼ wavelength plate 8.

Next, the ¼ wavelength plate 8 converts the polarization of the emitted blue-LASER beam BL from linear polarization to circular polarization, and emits the beam toward the compatibility element 9.

Also, the blue-LASER beam BL that passed through the compatibility element 9 is condensed by the object lens to its focal point, and then it is projected onto the optical disc (not shown in the figure).

Next, the direction of the circular polarization of the blue-LASER beam BL that is reflected by the optical disc is changed by the reflection, and the beam enters the object lens 10 again.

The object lens 10 returns the entering blue-LASER beam BL to a parallel beam, and emits it toward the compatibility element 9.

The compatibility element 9 lets the emitted blue-LASER beam BL pass through as is, and emits it toward the ¼ wavelength plate 8.

Next, as in the first and second embodiments, the ¼ wavelength plate 8 converts the polarization of the emitted blue-LASER beam BL from circular polarization to linear polarization, and emits the beam toward the turning prism 7.

The turning prism 7 changes the direction of the optic axis of the emitted blue-LASER beam BL to a horizontal direction, and emits it toward the second collimating lens 21.

The second collimating lens 21 then narrows the cross-sectional area of the light flux of the emitted blue-LASER beam BL, and emits it toward the dichroic prism 5.

Also, the dichroic prism 5 lets the emitted blue-LASER beam BL pass through, and emits it toward the polarization hologram 30.

The polarization hologram 30 corrects the color distortion of the emitted blue-LASER beam BL and lets the blue-LASER beam BL pass through, similar to the first collimating lens 20 in the second embodiment, and emits it toward the PBS 3. At the same time, the polarization hologram 30 performs the same action on the blue-LASER beam BL as the function of the detection lens 11 in the first or second embodiment to convert the form of the light flux of the blue-LASER beam BL emitted from the dichroic prism 5 to a light-flux form that can be received by the detector 12 as in the first or second embodiment.

Next, the PBS 3 reflects the blue-LASER beam BL from the polarization hologram 30, whose direction of polarization has changed 90-degrees compared to that when the beam is emitted from the semiconductor LASER 1, and changes the direction of its optical axis to an upward vertical direction, then emits it toward the detector 12.

The detector 12 then receives the emitted blue-LASER beam BL and generates a corresponding received-light signal, and outputs it to a demodulation-detection unit or the like (not shown in the figure).

Here, in the series of operations performed on the blue-LASER beam BL described above, the polarization hologram 30 functions as the first collimating lens 20 of the second embodiment described above based on the difference of polarization direction of the going and returning blue-LASER beam BL, and functions as the detection lens 11 in the first or second embodiments.

Next, since the operation of each part for the red-LASER beam RL is the same as in the case of the second embodiment described above, a detailed explanation will be omitted.

Also, in the series of operations performed on the red-LASER beam RL, the second collimating lens 21 acts on the red-LASER beam RL as a collimating lens that converts the red-LASER beam RL to a parallel beam as in the second embodiment.

In other words, in the optical pickup P3 of this third embodiment described above, the polarization hologram 30, together with the second collimating lens 21, functions as a spherical-distortion-correction element and collimating lens for the blue-LASER beam BL and its reflected beam, and further functions as the detection lens 11 in the first or second embodiment.

Therefore, when designing the lens of the polarization hologram 30 of this third embodiment, it is necessary to keep this point in mind and design a lens that can reduce the color distortion in the blue-LASER beam BL by the action of the second collimating lens 21, for example.

As explained above, with the construction of the pickup P3 of this third embodiment, the optic axis of the blue-LASER beam BL coincides with the optic axis of the red-LASER beam RL, and a dichroic prism 5 that guides the blue-LASER beam BL and red-LASER beam RL in the direction toward the optical disc is placed between the polarization hologram 30 and second collimating lens 21 in the optical path of the blue-LASER beam BL and its reflected beam; and the second collimating lens 21, working together with the polarization hologram 30, corrects spherical distortion in the blue-LASER beam BL and its reflected beam, as well as functions to convert the blue-LASER beam BL in the forward path to the optical disk to a parallel beam, and convert the red-LASER beam RL in the forward path to the optical disk to a parallel beam, so it is not necessary to have a special collimating lens for the red-LASER beam RL and a special collimating lens for the blue-LASER beam BL, and thus it is possible to further reduce the number of parts of the optical pickup P3 and make the optical pickup P3 more compact.

Furthermore, by placing the polarization hologram 30 between the dichroic prism 5 and PBS 3, it is also possible to omit the detection lens 11 in the first or second embodiment for the blue-LASER beam BL, and thus it is possible to further reduce the number of parts of the optical pickup P3 and make the optical pickup P3 more compact.

In the optical module 13 in the first thru the third embodiments described above, construction is also possible in which one optical module switches between an infrared beam (wavelength of 780 nm, for example) as a second light beam, and a red-LASER beam RL as a second light beam.

(IV) Embodiment 4

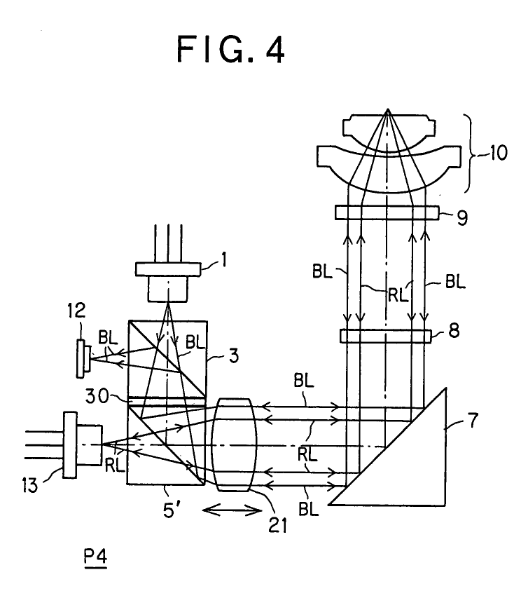

Next, FIG. 4 will be used to explain a fourth embodiment of the invention. FIG. 4 is a schematic diagram of the construction of the optical pickup of this fourth embodiment. Also, in FIG. 4, the same reference numbers will be used for parts that are identical with parts of the optical pickup P3 of the third embodiment shown in FIG. 3, and a detailed explanation of those parts will be partially omitted.

In the third embodiment described above, the case of reducing the number of parts of the optical pickup P3 by omitting a special collimating lens for the red-LASER beam RL, a special collimating lens 2 and a detection lens 11 for the blue-LASER beam BL was explained, however, in the fourth embodiment explained below, the space occupied by the optical pickup, comprising a dichroic prism having a different function than that of the third embodiment, is further reduced.

In other words, as shown in FIG. 4, the optical pickup P4 of this fourth embodiment comprises the same semiconductor LASER 1, PBS 3, turning prism 7, ¼ wavelength plate 8, compatibility element 9, object lens 10, detector 12, optical module 13, second collimating lens 21 and polarization hologram 30 as in the third embodiment, as well as comprises a dichroic prism 5′ that is different than that in the first thru third embodiments and that lets the red-LASER beam RL that enters pass through as is, and reflects the blue-LASER beam BL that enters.

Also, the dichroic prism 5′ lets the red-LASER beam RL pass through in both the path going to and the path returning from the optical disc, and reflects the blue-LASER beam BL in both the going and return paths.

As shown in FIG. 4, the semiconductor LASER 1, PBS 3 and detector 12 can be arranged in a direction parallel with the optical path between the turning prism 7 and object lens 10 with respect to the dichroic prism 5′, so it is possible to make the space occupied by the optical pickup P4 even more compact.

As explained above, with the construction of the optical pickup P1 of the first embodiment, the optic axis of the blue-LASER beam BL coincides with the optic axis of the red-LASER beam RL, and a dichroic prism 5 that guides the blue-LASER beam BL and red-LASER beam RL in the direction toward the optical disc is placed between the first expander 4 and second expander 6 in the optical path of the blue-LASER beam BL and its reflected beam; and the second expander lens 6, working together with the first expander lens 4, corrects spherical distortion in the blue-LASER beam BL and its reflected beam, as well as functions to convert the red-LASER beam RL in the forward path to the optical disk to a parallel beam, so it is not necessary to have a special collimating lens for the red-LASER beam RL, and thus it is possible to reduce the number of parts of the optical pickup P1 and make the optical pickup P1 more compact.

Also, with the construction of the pickup P2 of the second embodiment, the optic axis of the blue-LASER beam BL coincides with the optic axis of the red-LASER beam RL, and a dichroic prism 5 that guides the blue-LASER beam BL and red-LASER beam RL in the direction toward the optical disc is placed between the first collimating lens 20 and second collimating lens 21 in the optical path of the blue-LASER beam BL and its reflected beam; and the second collimating lens 21, working together with the first collimating lens 20, corrects spherical distortion in the blue-LASER beam BL and its reflected beam, as well as functions to convert the red-LASER beam RL in the forward path to the optical disk to a parallel beam, so it is not necessary to have a special collimating lens for the red-LASER beam RL and a special collimating lens 2 for the blue-LASER beam BL, and thus it is possible to further reduce the number of parts of the optical pickup P2 and make the optical pickup P2 more compact.

Furthermore, with the construction of the pickup P3 of this third embodiment, the optic axis of the blue-LASER beam BL coincides with the optic axis of the red-LASER beam RL, and a dichroic prism 5 that guides the blue-LASER beam BL and red-LASER beam RL in the direction toward the optical disc is placed between the polarization hologram 30 and second collimating lens 21 in the optical path of the blue-LASER beam BL and its reflected beam; and the second collimating lens 21, working together with the polarization hologram 30, corrects spherical distortion in the blue-LASER beam BL and its reflected beam, as well as functions to convert the blue-LASER beam BL in the forward path to the optical disk to a parallel beam, and convert the red-LASER beam RL in the forward path to the optical disk to a parallel beam, so it is not necessary to have a special collimating lens for the red-LASER beam RL and a special collimating lens 2 for the blue-LASER beam BL, and thus it is possible to further reduce the number of parts of the optical pickup P3 and make the optical pickup P3 more compact.

Furthermore, by placing the polarization hologram 30 between the dichroic prism 5 and PBS 3, it is also possible to omit the detection lens 11 in the first or second embodiment for the blue-LASER beam BL, and thus it is possible to further reduce the number of parts of the optical pickup P3 and make the optical pickup P3 more compact.

Also, with the construction of the optical pickup P4 of the fourth embodiment, the semiconductor LASER 1, PBS 3 and detector 12 can be arranged in a direction parallel with the optical path between the turning prism 7 and object lens 10 with respect to the dichroic prism 5′, so it is possible to make the space occupied by the optical pickup P4 even more compact.

In each of the embodiments described above, the case of applying the invention to an optical pickup that corresponds to a DVD and blue-LASER optical disc was explained, however, in addition to this it is also possible to apply the invention to an optical pickup that corresponds to both a CD and DVD.

Furthermore, this invention can be widely used in optical pickups that are used for optically recording or reproducing data using two kinds of optical beams having different wavelengths.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-355101 filed on Dec. 6, 2002 including the specification, claims, drawings and summary is incorporated herein by reference in its entirety.

What is claimed is

1. An optical apparatus that projects a first light beam having a first wavelength and a second light beam having a second wavelength that is different than said first wavelength onto an optical recording medium, and that guides a first reflected beam, which is the reflected beam of said first light beam that is reflected from said optical recording medium, and a second reflected beam, which is the reflected beam of said second light beam that is reflected from said optical recording medium, and comprising:
a distortion-correction device for correcting the distortion that occurs in said first light beam and first reflected beam, and comprises a stationary optical device and a movable optical device; and
a light-guiding device that is located between said stationary optical device and movable optical device in the optical path of said first light beam and said first reflected beam, and guides said first light beam and said second light beam, whose optic axes coincide with each other, to said optical recording device; and wherein
said movable optical device works together with said stationary optical device to correct said distortion, and converts said second light beam to a parallel beam.

2. The optical apparatus according to claim 1 wherein;
said distortion-correction device corrects said distortion and converts said first light beam to a parallel beam.

3. The optical apparatus according to claim 2 wherein;
said stationary optical device converts said first reflected light to the light-flux form necessary for receiving said first reflected beam.

4. The optical apparatus according to claim 3 wherein;
said stationary optical device is a polarization hologram that is formed on the incident surface where said first light beam enters said light-guiding device.

5. An optical pickup comprising:
an optical apparatus that projects a first light beam having a first wavelength and a second light beam having a second wavelength that is different than said first wavelength onto an optical recording medium, and that guides a first reflected beam, which is the reflected beam of said first light beam that is reflected from said optical recording medium, and a second reflected beam, which is the reflected beam of said second light beam that is reflected from said optical recording medium, and comprising: a distortion-correction device for correcting the distortion that occurs in said first light beam and first reflected beam, and comprises a stationary optical device and a movable optical device; and a light-guiding device that is located between said stationary optical device and movable optical device in the optical path of said first light beam and said first reflected beam, and guides said first light beam and said second light beam, whose optic axes coincide with each other, to said optical recording device; and wherein said movable optical device works together with said stationary optical device to correct said distortion, and converts said second light beam to a parallel beam;
a first light-beam-emitting device for emitting said first light beam;
a second light-beam-emitting device for emitting said second light beam;
a first light-receiving device for receiving said first reflected beam that passes through said optical apparatus, and generating a corresponding first received-light signal; and
a second light-receiving device for receiving said second reflected beam that passes through said optical apparatus, and generating a corresponding second received-light signal.
